(19) United States
(12) Patent Application Publication
(10) Pub. No.: US 2024/0424438 A1
(43) Pub. Date: Dec. 26, 2024

(54) METHOD AND APPARATUS FOR PRODUCING HYDROGEN FROM WATER

(71) Applicant: CLEAN POWER HYDROGEN GROUP LIMITED, Doncaster (GB)

(72) Inventors: Nigel Williamson, Dronfield (GB); Ian Pillay, Scunthorpe (GB)

(21) Appl. No.: 18/683,741

(22) PCT Filed: Aug. 17, 2022
(86) PCT No.: PCT/EP2022/072934

§ 371 Date: Feb. 14, 2024

(30) Foreign Application Priority Data
Aug. 18, 2021 (GB) 2111877.3

(51) Int. Cl. B01D 53/04; C01B 3/00; C25B 1/04; C25B 9/60; F17C 1/00; F17C 11/00

(52) U.S. Cl. CPC B01D 53/0415; C01B 3/001; C25B 1/04; C25B 9/60; F17C 1/005; F17C 11/005; B01D 2253/1126; B01D 2256/16; B01D 2257/104; B01D 2259/40088; F17C 2201/0109; F17C 2221/012; F17C 2265/066; F17C 2270/0178

(57) ABSTRACT

A method of producing hydrogen comprises electrolysing water to produce a mixture of hydrogen and oxygen gases. passing the mixture into a chamber containing a hydrogen storage medium to store the hydrogen by adsorption therein, venting the oxygen from the chamber, and subsequently treating the hydrogen storage medium to release the hydrogen stored therein. Apparatus for producing hydrogen from water comprises an electrolyser unit (1, 2) having mounted thereon a chamber (5) in communication with a gas outlet (3) from the electrolyser. the chamber containing a hydrogen storage medium (4) and being provided with means (8) for venting oxygen from the chamber.

### FIELD OF THE INVENTION

This invention relates to a method and apparatus for producing hydrogen from water.

### BACKGROUND TO THE INVENTION

Electrolysis of water is currently seen as a possible way of storing energy captured by arrays of photovoltaic cells or wind turbines, with hydrogen being stored for use as a fuel, for example in fuel cells or in internal combustion engines, as higher energy densities can be achieved than with current electric battery technology, for example. The separation of the hydrogen from the oxygen can be achieved by special design of the electrolysis cells, for example as disclosed in WO2015/118073A, or by treating the mixed gas stream from cells such as those disclosed in WO2014/170337A or GB2515292A in a cryogenic separator in which the mixed gases are cooled by liquid nitrogen to condense the oxygen, allowing the removal of gaseous hydrogen. Both these approaches are relatively costly, and if the separated hydrogen is not to be used at the location of the power generation technology the hydrogen needs to be compressed and stored for transportation. The simplest approach to water decomposition is to generate a mixed gas (hydrogen and oxygen), where no membrane to separate the gases is incorporated in the electrolyser cell, thereby eliminating associated resistance to the passage of ions.

It is known to use metal hydride materials for the storage of the separated hydrogen, the hydrogen then being released, for example by heating the material. For example, in US2005/211573A a hydrogen storage unit is disclosed which contains a plurality of compartments containing hydrogen storage material which stores hydrogen in metal hydride form. Various different metal alloy hydrogen storage materials are disclosed. New hydrogen adsorption media are being developed around the world which are now close to commercialisation. These may be in granular form, or retained in matrices of various kinds, or on thin film. All will be contained in canisters which can either be depleted of their hydrogen content and replenished, or removed and replaced with fully hydrogen-charged canisters. De-adsorption of the hydrogen in such systems is achieved by various means, most commonly, the addition of heat, though materials which require lasers or UV light to desorb the hydrogen may also be used.

CN101841277A discloses a system in which hydrogen is produced by electrolysis of water using a “medium and high pressure water electrolysis hydrogen production system”, in other words the type of electrolysis cell that produces separate hydrogen and oxygen streams. As previously mentioned, such systems are relatively costly, incorporating a special membrane. The resulting hydrogen can then be stored in a metal hydride storage device until required for fuelling a fuel cell power generation device.

The main benefits of such media relate to safety of storage, where pressures are typically below 50 bar, and to volume utilisation, when compared with other storage technologies. However, such materials have typically been deployed for storage of purified hydrogen, where the hydrogen and oxygen from electrolysis of water have already been separated and individually purified.

### SUMMARY OF THE INVENTION

The present invention provides a method of producing hydrogen, comprising:
electrolysing water to produce a mixture of hydrogen and oxygen gases;
passing the mixture into a chamber containing a hydrogen storage medium to store the hydrogen by adsorption therein;
venting the oxygen from the chamber; and
subsequently treating the hydrogen storage medium to release the hydrogen stored therein.

The invention also provides apparatus for producing hydrogen from water, comprising an electrolyser unit having mounted thereon a chamber in communication with a gas outlet from the electrolyser, the chamber containing a hydrogen storage medium and being provided with means for venting oxygen from the chamber.

This invention relates to the development of a combination electrolysis and hydrogen storage system which produces a mixed gas—but avoids the cost and power demands associated with separating them. This invention uses a hydrogen/oxygen production system, close-coupled to a storage technology which preferentially adsorbs the hydrogen while allowing the oxygen to flow past the adsorbing medium without the storage medium being deleteriously affected by it. The oxygen could separately be stored for recombination with the stored hydrogen (thereby eliminating the potential for generation of NOₓ) or vented to atmosphere.

The electrolyser directly feeds a mixed gas through a drying system (where necessary) to an adsorption canister in which an appropriately specified hydrogen adsorption medium is contained. As the electrolysis reaction is self-pressurising, the pressure required to force adsorption does not otherwise need to be generated.

Downstream of these gas generation, drying and adsorption modules would be control technologies which would allow off-take of the oxygen for subsequent storage or venting.

When the hydrogen is required to flow, specified release technologies would be deployed (by heating, exposure to light, for example UV light, or laser scanning, or other radiation) to break the bond between the gas and the storage medium. Such a system may be conceived for large-scale applications, but may also be developed for small systems for refuelling vehicles at home or on a forecourt, preferably driven by electricity from renewable and sustainable sources such as domestic photovoltaic panels.

The invention combines membrane free electrolyser with storage using a hydrogen storage medium, for example a metal hydride, that is hydrogen selective to:
a. Filter and purify the hydrogen from the stoichiometric hydrogen and oxygen gas mixture.
b. Store the hydrogen gas.
c. Release the purified hydrogen gas as demand requires for downstream utilisation.

The benefits of this combination of technology are wide with the following being of the highest importance to wider adoption of hydrogen technology:
a. Hydrogen is not stored as a gas, reducing both volume and safety related pressure issues of storing gaseous fuels.
b. The system space envelope is greatly reduced as the hydrogen storage medium can be close coupled to the membrane free electrolyser.
c. Energy costs associated with other methods of hydrogen purification are negated.
d. Space and component weight required for storage of the hydrogen are significantly reduced when compared with other storage technologies.

### BRIEF DESCRIPTION OF THE DRAWINGS

In the drawings, which illustrate an exemplary embodiment of the invention:

FIG. 1 is a diagrammatic view representing apparatus for the production of hydrogen from water according to an embodiment of the invention; and

FIG. 2 is a diagram illustrating the use of the apparatus in the fuelling of a hydrogen-powered vehicle.

### DETAILED DESCRIPTION OF THE ILLUSTRATED EMBODIMENT

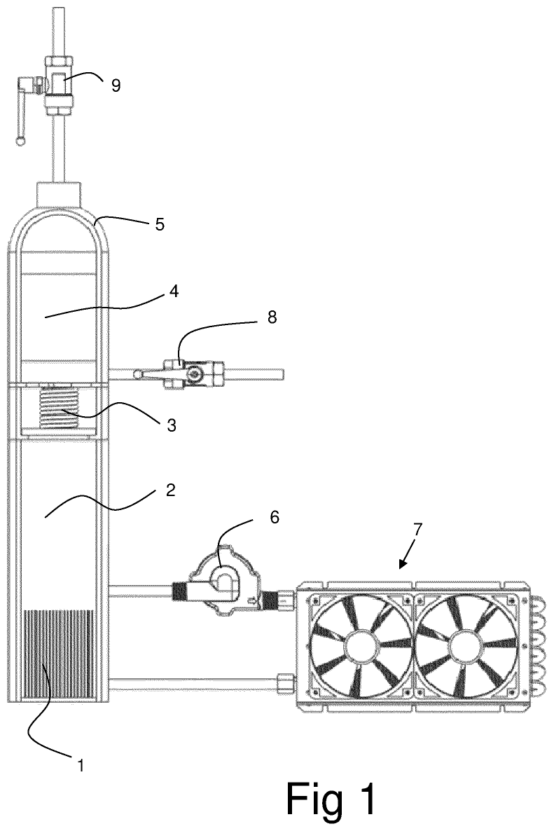

Referring to FIG. 1, a water electrolyser system for the provision of pure hydrogen and oxygen gases comprises an electrolyte reservoir/separating cylinder 2, a reactor stack 1 in which the water is decomposed into its component parts of hydrogen and oxygen gases, a heat rejection system 7 which maintains the temperature of the electrolyte, a water replenishment system, an electrolyte recirculation pump 6, an electrolyte monitoring and maintenance system, a fluid control system, a one way pressure-actuated non-return valve 3, a metal hydride or other adsorption medium filter purifier 4 in a pressure capable vessel 5, oxygen vent valve 8, hydrogen vent valve 9 and a control system.

The reactor stack 1 and associated electrolyte circulation 6 and cooling (heat rejection) system 7 are generally as disclosed in WO 2014/170337 A1 and will therefore not be described in detail here. In a typical stack of this design, electrolyte (e.g. KOH) concentrations can vary widely from a low of 0.5% to a high of 30% (w/w). However, in order to reduce reactivity and the potential for personal and environmental damage, a concentration of around 2% is preferred.

There are numerous metal hydrides (e.g. nickel metal hydrides, lithium hydride, and lithium 6 deuteride) and compounds (e.g. lithium aluminium hydride, ammonia borane and sodium borohydride) which have strong hydrogen adsorption capacities. These may be produced in bead or granular form, deposited as a thin coating on film substrates or housed in lattices within appropriately-designed, typically cylindrical, vessels. Other materials capable of adsorbing and releasing hydrogen selectively are currently under development, for example based on carbon nano-tubes or graphene.

Venting the oxygen may be done in batch releases on attainment of pressures in excess of those required for hydrogen adsorption, with a substantial release at reduced pressure at the end of each charge cycle to eliminate the last of the oxygen.

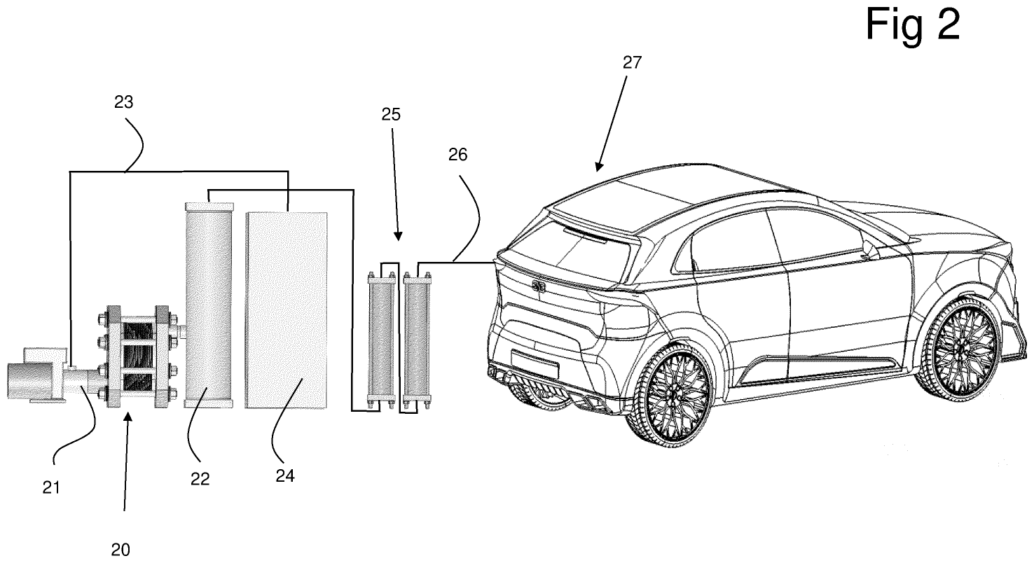

In the embodiment shown in FIG. 2, the reactor stack 20 is a membrane-free electrolytic cell arrangement supplied with electricity from, for example, photovoltaic panels and with aqueous electrolyte by a pump 21. The stack produces a mixed-gas stream of hydrogen and oxygen, the gases being separated from excess electrolyte in a separator 22, from which the electrolyte is returned to the reactor 20 via an electrolyte line 23 by the pump 21. The mixed gases pass through a heat exchanger 24 to maintain the elevated temperature of the electrolyte, and then into a gas dryer 25. The gas dryer 25 may comprise a pre-drying stage and then a desiccant stage. The pre-drying stage, whose purpose is to reduce the workload on the desiccant stage, suitably consists of one or more of: a cooled water cylinder through which the moist gas is bubbled; a vortex generator where differential masses are separated out by velocity; and a dash-pot in which different diameters are used to create different velocities.

A mixed gas supply line 26 can direct the output of the gas dryer 25 to a hydride separation and storage tank installed in a vehicle 27. The separation and storage tank 27 is essentially a pressure capable vessel as described with reference to FIG. 1, containing a metal hydride or other adsorption medium filter purifier, and having an oxygen vent valve which vents oxygen to the atmosphere. Alternative configurations may be employed in which the oxygen is captured for storage and subsequent use.

The separation and storage tank may be configured to apply heat to the storage medium to release hydrogen from it for use in the drive system of the vehicle, for example a fuel cell providing electricity to an electric drive motor.

1. A method of producing hydrogen, comprising:
electrolysing water to produce a mixture of hydrogen and oxygen gases; and
separating the hydrogen from the oxygen,
wherein the separation stage comprises
passing the mixture into a chamber containing a hydrogen storage medium whereby to separate the hydrogen by adsorption into the storage medium;
venting the oxygen from the chamber; and
subsequently treating the hydrogen storage medium to release the hydrogen stored therein.

2. The method according to claim 1, further comprising electrolysing water using a membrane free electrolyser.

3. The method according to claim, further comprising storing the vented oxygen for use.

4. The method according to claim 1, further comprising using a metal hydride as the hydrogen storage medium.

5. The method according to claim 1, wherein the chamber is in the form of a detachable cartridge.

6. The method according to claim 1, further comprising heating the hydrogen storage medium to release the hydrogen.

7. The method according to claim 1, further comprising exposing the hydrogen storage medium to light to release the hydrogen.

8. An apparatus for producing hydrogen from water, comprising an electrolyser unit having mounted thereon a chamber in communication with a gas outlet from the electrolyser, the chamber containing a hydrogen storage medium and being provided with means for venting oxygen from the chamber.

9. The apparatus according to claim 8, wherein the chamber is connected to the gas outlet of the electrolyser via a releasable coupling.

10. The apparatus according to claim 8, wherein the electrolyser is a membrane free electrolyser.

11. The apparatus according to claim 8, wherein the vented oxygen is stored for use.

12. The apparatus according to claim 8, wherein the chamber contains a metal hydride as the hydrogen storage medium.

13. The apparatus according to claim 8, wherein the chamber is in the form of a detachable cartridge.
